(19) United States
(12) Patent Application Publication
(10) Pub. No.: US 2007/0200071 A1
(43) Pub. Date: Aug. 30, 2007

(54) Coupling output from a micro resonator to a plasmon transmission line

(75) Inventors: Jonathan Gorrell, Gainesville, FL (US); Mark Davidson, Florahome, FL (US); Michael E. Maines, Gainesville, FL (US)

Correspondence Address: DAVIDSON BERQUIST JACKSON & GOWDEY LLP, 4300 WILSON BLVD., 7TH FLOOR, ARLINGTON, VA, 22203, US

(73) Assignee: Virgin Islands Microsystems, Inc., St. Thomas, VI (US)

(21) Appl. No.: 11/418,315

(22) Filed: May 5, 2006

Related U.S. Application Data
(60) Provisional application No. 60/777,120, filed on Feb. 28, 2006.

(51) Int. Cl. G01K 1/08

(52) U.S. Cl. 250/400

(57) ABSTRACT

A device for coupling output from a resonant structure to a plasmon transmission line includes a transmission line formed adjacent at least one element of the light-emitting resonant structure; a detector microcircuit disposed adjacent to the transmission line and wherein a beam of charged particles electrically couples the a plasmon wave traveling along the metal transmission line to the microcircuit.

### CROSS-REFERENCE To RELATED APPLICATIONS PRIORITY APPLICATION

This application is related to and claims priority from the following co-pending U.S. Patent application, the entire contents of which is incorporated herein by reference: U.S. Provisional Patent Application No. 60/777,120, titled “Systems and Methods of Utilizing Resonant Structures,” filed Feb. 28, 2006 [Atty. Docket No. 2549-0087].

### COPYRIGHT NOTICE

A portion of the disclosure of this patent document contains material which is subject to copyright or mask work protection. The copyright or mask work owner has no objection to the facsimile reproduction by anyone of the patent document or the patent disclosure, as it appears in the Patent and Trademark Office patent file or records, but otherwise reserves all copyright or mask work rights whatsoever.

### RELATED APPLICATIONS

The present invention is related to the following co-pending U.S. Patent applications which are all commonly owned with the present application, the entire contents of each of which are incorporated herein by reference:

1. U.S. application Ser. No. 11/302,471, entitled “Coupled Nano-Resonating Energy Emitting Structures,” filed Dec. 14, 2005 [atty. docket 2549-0056],

2. U.S. application Ser. No. 11/349,963, filed Feb. 9, 2006, entitled “Method And Structure For Coupling Two Microcircuits,” [Atty. Docket 2549-0037];

3. U.S. Patent application Ser. No. 11/238,991 [atty. docket 2549-0003], filed Sep. 30, 2005, entitled “Ultra-Small Resonating Charged Particle Beam Modulator”;

4. U.S. patent application Ser. No. 10/917,511, filed on Aug. 13, 2004, entitled “Patterning Thin Metal Film by Dry Reactive Ion Etching”;

5. U.S. application Ser. No. 11/203,407, filed on Aug. 15, 2005, entitled “Method Of Patterning Ultra-Small Structures”;

6. U.S. application Ser. No. 11/243,476 [Atty. Docket 2549-0058], filed on Oct. 5, 2005, entitled “Structures And Methods For Coupling Energy From An Electromagnetic Wave”;

7. U.S. application Ser. No. 11/243,477 [Atty. Docket 2549-0059], filed on Oct. 5, 2005, entitled “Electron beam induced resonance,”

8. U.S. application Ser. No. 11/325,448, entitled “Selectable Frequency Light Emitter from Single Metal Layer,” filed Jan. 5, 2006 [Atty. Docket 2549-0060];

9. U.S. application Ser. No. 11/325,432, entitled, “Matrix Array Display,” filed Jan. 5, 2006 [Atty. Docket 2549-0021],

10. U.S. application Ser. No. 11/410,905, entitled, “Coupling Light of Light Emitting Resonator to Waveguide,” and filed Apr. 26, 2006 [Atty. Docket 2549-0077];

11. U.S. application Ser. No. 11/411,120, entitled “Free Space Interchip Communication,” and filed Apr. 26, 2006 [Atty. Docket 2549-0079];

12. U.S. application Ser. No. 11/410,924, entitled, “Selectable Frequency EMR Emitter,” filed Apr. 26, 2006 [Atty. Docket 2549-0010];

13. U.S. Application Ser. No. 11/______, entitled, “Multiplexed Optical Communication between Chips on A Multi-Chip Module,” filed on even date herewith [atty. docket 2549-0035];

14. U.S. patent application Ser. No. 11/400,280, entitled “Resonant Detector for Optical Signals,” filed Apr. 10, 2006, [Atty. Docket No. 2549-0068]; and

15. U.S. patent application Ser. No. 11/______, entitled “Coupling energy in a plasmon wave to an electron beam,” filed on even date herewith [Atty. Docket 2549-0072].

### FIELD OF THE DISCLOSURE

This relates to ultra-small electronic devices, and, more particularly, to coupling output from a light emitting micro resonator to a plasmon transmission line.

### INTRODUCTION

It is known to couple light onto the surface of a metal, creating a so-called plasmon wave. This effect has been used for, e.g., near-field optical microscopy.

Co-pending and related U.S. patent application Ser. No. 11/______, [Atty. Docket 2549-0072], filed on even date herewith and entitled “Coupling energy in a plasmon wave to an electron beam,” the entire contents of which have been incorporated herein by reference, discloses methods and devices for coupling energy in a plasmon wave to an electron beam, thereby facilitating, inter alia, the use of plasmons to communicate data.

Many of the related applications describe ultra-small resonant structures that may produce electromagnetic radiation (EMR) when exposed to a beam of charged particles. Generally, the ultra-small resonant structures may emit light (such as infrared light, visible light or ultraviolet light or any other EMR at a wide range of frequencies, and often at a frequency higher than that of microwave). The EMR is emitted when the resonant structure is exposed to a beam of charged particles ejected from or emitted by a source of charged particles. Preferably the particle beam passes adjacent the structures, the term “adjacent” including, without limitation, above the structures. The source may be controlled by applying a signal on data input. The source can be any desired source of charged particles such as an ion gun, a Thermionic filament, tungsten filament, a cathode, a field emission cathode, a vacuum triode, a planar vacuum triode, an electron-impact ionizer, a laser ionizer, a chemical ionizer, a thermal ionizer, an ion-impact ionizer, an electron source from a scanning electron microscope, etc. The particles may be positive ions, negative ions, electrons, and protons and the like.

It is desirable to couple the output of a ultra-small resonant device to a plasmon transmission line.

It is further desirable to detect plasmons on such a line.

### BRIEF DESCRIPTION OF THE DRAWINGS

The following description, given with respect to the attached drawings, may be better understood with reference to the non-limiting examples of the drawings, wherein:

FIGS. 1-4 are top views of ultra-small devices including coupled plasmon transmission lines.

### THE PRESENTLY PREFERRED EXEMPLARY EMBODIMENTS

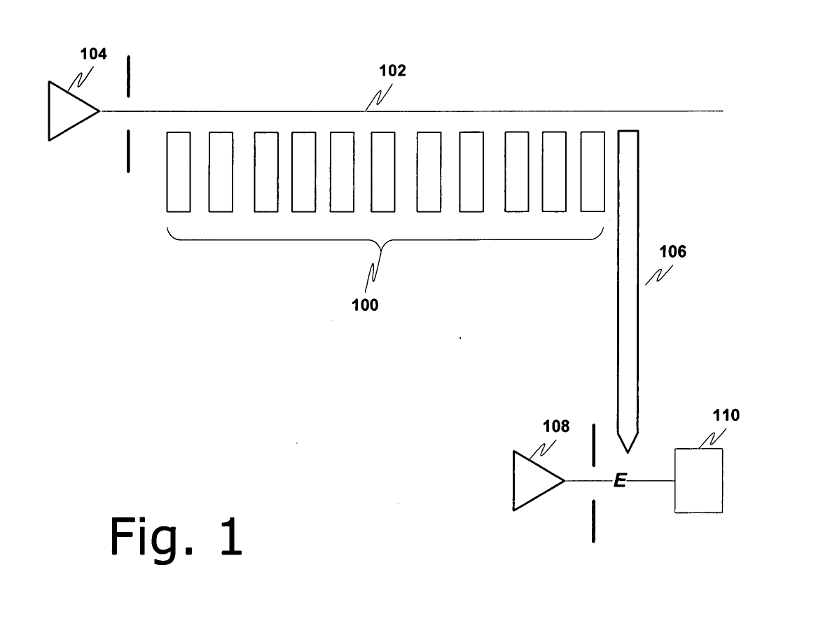

FIG. 1 shows an ultra-small resonant device 100 consisting of a number of so-called “resonators.” As has been described in the related applications, the fingers 100 will emit EMR (light) when a beam of charged particles 102 is passed near them. The device 100 is formed on a substrate (not shown). The source 104 of the charged particles may be controlled by applying a signal on data input. The source can be any desired source of charged particles such as an ion gun, a Thermionic filament, tungsten filament, a field emission cathode, a cathode, a vacuum triode, a planar vacuum triode, an electron-impact ionizer, a laser ionizer, a chemical ionizer, a thermal ionizer, an ion-impact ionizer, an electron source from a scanning electron microscope, etc. The particles may be positive ions, negative ions, electrons, and protons and the like. The source 104 of charged particles may be formed on the same substrate as the device or elsewhere.

A transmission line 106 is formed adjacent at least one of the fingers of the device 100. The transmission line 106 (preferably a metal line) preferably has a pointed end, although this is not necessary. A source of charged particles 108 and a corresponding detector 110 are positioned near the (pointed) end of the transmission line 106. Preferably the source 108 and detector 110 are positioned so that a beam of charged particles (denoted E in the drawing) generated by the source 108 is disrupted or deflected by a change in the magnetic and/or electric field surrounding the end of the transmission line 106. In some cases the beam E may be substantially perpendicular to a central axis of the transmission line. The line may be formed underneath or on top of an element of the resonant structure.

When the charged particle beam 102 passes adjacent the ultra-small resonant structure 100, the structure emits light and oscillating electric fields which, in turn, cause a plasmon wave to travel along the line 106. This wave causes disruption in the magnetic and/or electric field surrounding the end of the line, which, in turn, disrupts the beam E. Disruption of the beam E is detected by detector 110.

The detector 110 may provide a signal to other circuitry (not shown) indicative of its detection of plasmon waves in the line. I.e., indicative of light and oscillating electric fields being generated by the device 100.

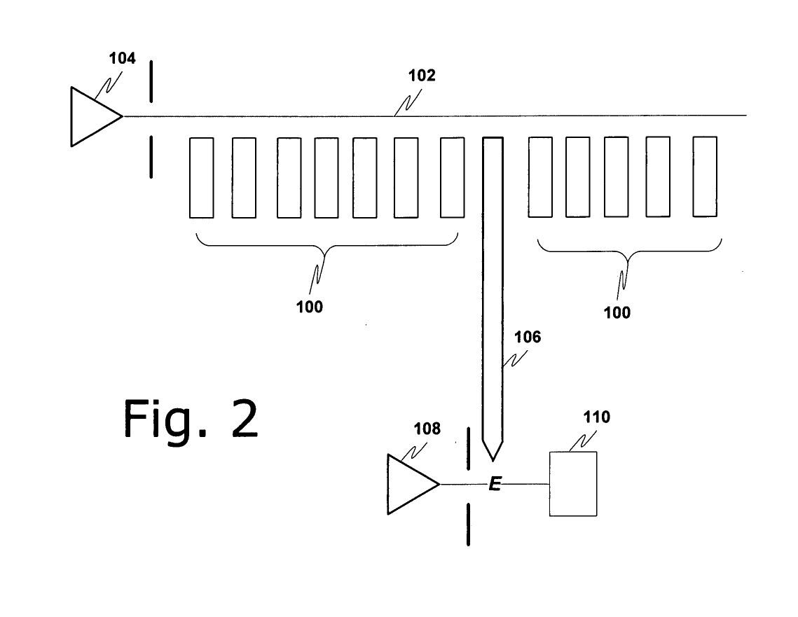

As shown in FIG. 2, the line 106 need not be at the end of the structure 100, but can, instead, be within it.

The line 106 should preferably be spaced from adjacent component(s) of the resonant structure at least as close as the other components of the resonant structure are to each other.

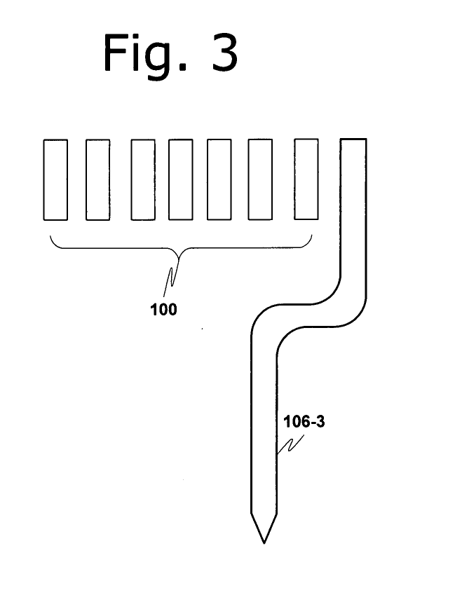

Although shown as straight in FIGS. 1-2, the line may also be curved, e.g., as shown in FIG. 3 (line 106-3).

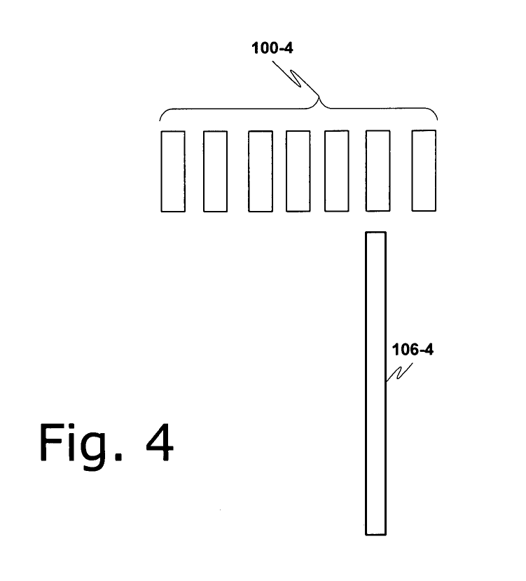

FIG. 4 shows an example in which the transmission line 106-4 is positioned adjacent one of the components of the resonant structure.

The detector 110 may be any detector, e.g., as disclosed in co-pending and related application Ser. No. 11/400,280 [Atty. Docket 2549-0068], which has been fully incorporated herein by reference.

Since the particle beam emitted by the source of charged particles may be deflected by any electric or magnetic field, one or more shields or shielding structure(s) may be added to block out unwanted fields. Such shield(s) and/or shielding structure(s) may be formed on the same substrate as the source of charged particles and/or the transmission line so that only fields from the transmission line will interact with the particle beam.

The devices according to embodiments of the present invention may be made, e.g., using techniques such as described in U.S. patent application Ser. No. 10/917,511, entitled “Patterning Thin Metal Film by Dry Reactive Ion Etching” and/or U.S. application Ser. No. 11/203,407, entitled “Method Of Patterning Ultra-Small Structures,” both of which have been incorporated herein by reference. The nano-resonant structure may comprise any number of resonant microstructures constructed and adapted to produce EMR, e.g., as described above and/or in U.S. application Ser. No. 11/325,448, entitled “Selectable Frequency Light Emitter from Single Metal Layer,” filed Jan. 5, 2006 [Atty. Docket 2549-0060], U.S. application Ser. No. 11/325,432, entitled, “Matrix Array Display,” filed Jan. 5, 2006, and U.S. application Ser. No. 11/243,476 [Atty. Docket 2549-0058], filed on Oct. 5, 2005, entitled “Structures And Methods For Coupling Energy From An Electromagnetic Wave”; U.S. application Ser. No. 11/243,477 [Atty. Docket 2549-0059], filed on Oct. 5, 2005, entitled “Electron beam induced resonance;” and U.S. application Ser. No. 11/302,471, entitled “Coupled Nano-Resonating Energy Emitting Structures,” filed Dec. 14, 2005 [atty. docket 2549-0056].

While certain configurations of structures have been illustrated for the purposes of presenting the basic structures of the present invention, one of ordinary skill in the art will appreciate that other variations are possible which would still fall within the scope of the appended claims. While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. A device for coupling output from a resonant structure to a plasmon transmission line, the device comprising:
a transmission line formed adjacent at least one element of the resonant structure; and
a detector microcircuit disposed adjacent the transmission line and wherein a beam of charged particles electrically couples the a plasmon wave traveling along the metal transmission line to the detector microcircuit.

2. A device as in claim 1 wherein the transmission line is at an end of the resonant structure.

3. A device as in claim 1 wherein the generator mechanism is selected from the group comprising:
an ion gun, a Thermionic filament, tungsten filament, a cathode, a vacuum triode, a field emission cathode, a planar vacuum triode, an electron-impact ionizer, a laser ionizer, a chemical ionizer, a thermal ionizer, an ion-impact ionizer.

4. A device as in claim 1 wherein the beam of charged particles comprises particles selected from the group comprising:
positive ions, negative ions, electrons, and protons and the like.

5. A device as in claim 1 wherein the detector microcircuit detects the presence of a plasmon wave in the transmission line.

6. A device as in claim 1 wherein the detector microcircuit detects the absence of a plasmon wave in the transmission line.

7. A device as in claim 1 wherein the transmission line is formed from a metal.

8. A device as in claim 6 wherein the metal comprises silver (Ag).

9. A device as in claim 1 wherein the transmission line has a pointed end and wherein the detector microcircuit is disposed adjacent the pointed end of the transmission line.

10. A device as in claim 1 further comprising:
shielding structure disposed to prevent interference with the beam of charged particles by sources of electromagnetic radiation (EMR) other than EMR from the transmission line.

11. A device as in claim 1 further comprising a generator mechanism constructed and adapted to generate a beam of charged particles.
